(19) United States
(12) Patent Application Publication
(10) Pub. No.: US 2005/0007867 A1
(43) Pub. Date: Jan. 13, 2005

(54) Hand mixer with eccentrically rotating and orbiting attachment

(76) Inventor: David J. Wanat, Meriden, CT (US)

Correspondence Address: STEVEN A. GARNER;CONAIR CORPORATION, ONE CUMMINGS POINT ROAD, STAMFORD, CT, 06902, US

(21) Appl. No.: 10/886,462

(22) Filed: Jul. 7, 2004

Related U.S. Application Data
(60) Provisional application No. 60/485,124, filed on Jul. 7, 2003.

(51) Int. Cl. A47J 43/044

(52) U.S. Cl. 366/129

(57) ABSTRACT

A handheld mixer has a body comprising a housing that houses a motor and drive system and an integral handle, and to an eccentric drive arrangement that is adapted to accept a single mixer attachment that is rotatably mounted about its own axis and that is orbitally mounted about a second, parallel moving axis in order to impart an eccentric orbit in combination with rotation.

### CROSS-REFERENCE TO RELATED APPLICATIONS

This application claims priority to U.S. Provisional Patent Application Ser. No. 60/485,124 filed on Jul. 7, 2003, incorporated herein by reference in its entirety.

### BACKGROUND OF THE INVENTION

1. Field of the Invention

The present invention relates to appliances such as food appliances and, more particularly, to handheld mixers that are powered by an electric motor and that have one or more attachments for a variety of food mixing operations and conditions.

2. Description of Related Art

It is known in the art to provide handheld, electric mixers comprising a body that houses an electric motor and drive system with an integral handle so that a user may hold the mixer in his or her hand during use. Known mixers of this type have a pair of chucks or similar attachment means for selectively attaching mixer attachments such as egg beaters or dough hooks. The pair of chucks are driven by the drive system and, thus, impart rotational movement to the mixer attachments.

Such mixers have various shortcomings including limited size of the mixer attachments because each of the pair of mixing attachments must coexist in a relatively small space without physically interfering with the other. Thus, the rotational work radius of each mixer attachment head is limited. Also, the flow of food product between the simultaneously moving mixer attachments becomes turbulent due to the effects of both mixer attachments at the same time. In addition, food product that is not easily mixed or crushed may get momentarily stuck between the mixer attachments causing undue wear or strain on the motor, the drive gears, and the attachments themselves. Another drawback of known handheld mixers is that the user is required to rotate the entire mixer in a circular or orbital path while the individual mixer attachments are spinning in order to obtain desired mixing. This can cause user fatigue.

It is desirable, therefore, to provide a handheld mixer that overcomes the abovementioned shortcomings of known handmixers, and that achieves further advantages that are inherent to the embodiments described below.

These and other objects are achieved by the present invention described herein.

### BRIEF SUMMARY OF THE INVENTION

The present invention handheld mixer is directed to a body comprising a housing that houses a motor and drive system and an integral handle, and to an eccentric drive arrangement that is adapted to accept a single mixer attachment that is rotatably mounted about its own axis and that is orbitally mounted about a second, parallel moving axis in order to impart an eccentric orbit in combination with rotation. To date, the existence of such compound motion of mixing attachments—both rotational and orbital—is limited to free standing mixers what tend to be much larger and heavier.

### BRIEF DESCRIPTION OF THE DRAWINGS

FIG. 1 is a perspective illustration of a hand mixer according to the preferred embodiment of the present invention.

FIG. 2 is a diagrammatic illustration of a bottom view of a component of the present invention.

### DESCRIPTION OF THE PREFERRED EMBODIMENT

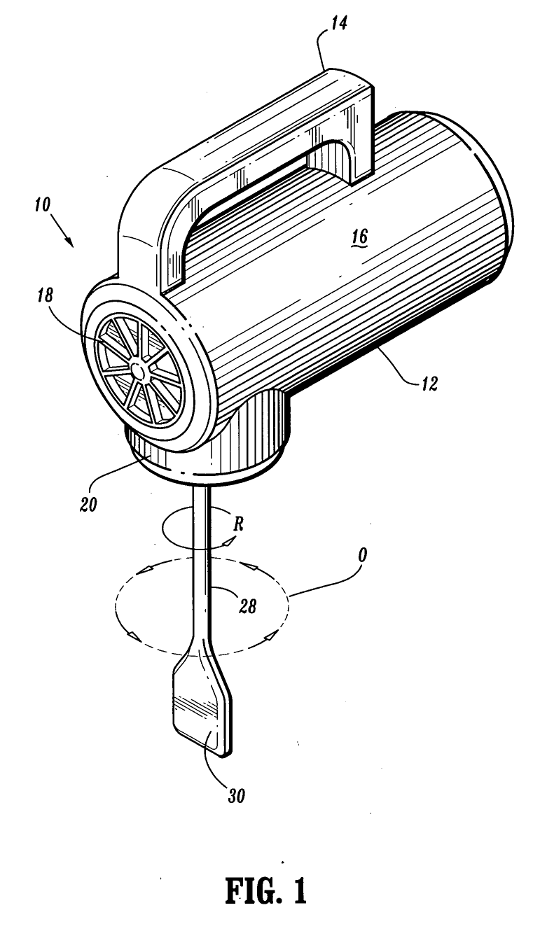

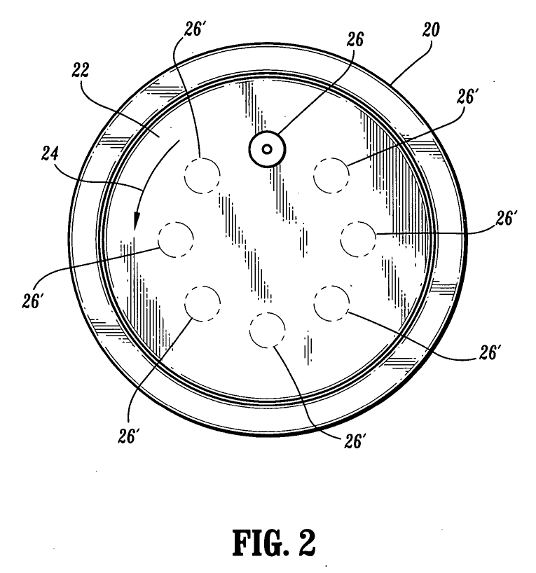

A handheld mixer (10) according to the present invention is shown in FIG. 1. The mixer (10) comprises a housing (12) having an integral handle (14), a motor housing section (16) for housing an electrical motor (not shown) therein, an air vent (18) for cooling the electric motor, and a mixer attachment base (20). The base (20) is generally round in cross-section, as shown in FIG. 2, and it houses a rotatable part (22) that is driven by the motor to rotate within the base (20) as shown by the arrow (24) in FIG. 2, and the letter “O” in FIG. 1. The rotatable part (22) includes a chuck (26) that is adapted to rotate with the rotatable part (22) in accordance with arrow (24) or “O”, and that is adapted to independently rotate about its own axis as shown by the letter “R” in FIG. 1. The chuck (26) is fitted with a selectively attachable and removable mixer attachment (28) having a paddle (30) as shown in FIG. 1, or having another type of head such as a dough hook, a whisk, or other mixing head. A particular advantage of the present invention over known handheld mixers is the ability to use a large curvature dough hook since there is no spatial limitation existing due to the presence of two attachments side-by-side. Ordinarily, such large dough hooks can only be used with free standing mixers that use a single mixer attachment.

The compound movement of the attachment, orbital and rotational, is achieved by an internal gearing arrangement (not shown) that is a planetary gear system of the type known to those generally skilled in the art. Essentially, a single output shaft from the motor, as is commonly known, is geared to drive multiple “planet” gears in coordination with an internally toothed ring gear, and then to a single output shaft that drives the chuck (26). This gearing arrangement per se is not regarded as novel, but instead novelty is in the combination of the gearing arrangement with the other elements of the present invention including the single mixer attachment in use with a handheld mixer.

Thus, the handheld mixer (10) may be held in a user's hand and the mixer attachment (28) is lowered into a bowl or other food container with food to be mixed. The electric motor is powered causing the attachments (28) to spin about its own axis as shown by “R” in FIG. 1, and to orbit about a path defined by “O” in FIG. 1. Referring to FIG. 2, the orbital path “O” is illustrated by the phantom images (26′) of the chuck (26). Because of the simultaneous orbital and rotational movement of the attachment, it is not necessary for the user to manipulate or move the entire mixer (10). This is a substantial improvement over the handheld mixers known in the art. Thus, it is possible to implement optional feature such as a securing device (not shown) or lid attachment for a bowl (not shown) that stabilizes or holds the mixer (10) stationary to the mixing bowl. Various other features not specifically described here may be included, such as variable speed controls, lighted displays, audible signals, rechargeable batteries, an electrical cord reel, push-button or touch pad controls, and other features.

While the preferred embodiment of the present invention has been described, it is understood that various modification and variation may be made without departing from the scope of the present invention.

1. A handheld mixer comprising:
a housing;
a motor and drive system within said housing;
a handle integral with said housing;
an attachment for mixing; and
a base that houses a rotatable section that rotates within said base and a chuck within said rotatable section, wherein said chuck is adapted to simultaneously rotate about a first axis and orbit about a second, moving axis that is parallel to said first axis.

2. A handheld mixer according to claim 1, wherein
said chuck holds said attachment for mixing and enables said attachment for mixing to rotate within said base about said first axis and orbit about said second, moving axis that is parallel to said first axis.

3. A handheld mixer according to claim 1, wherein
said chuck is driven by a first output shaft that drives a plurality of gears in coordination with an internally toothed ring gear and a second output shaft that drives said chuck.

4. A handheld mixer according to claim 1, wherein
said attachment for mixing is selectively attachable and removable.

5. A handheld mixer according to claim 1, further comprising
an air vent for cooling said motor and drive system.

6. A handheld mixer according to claim 1, wherein
said attachment for mixing is a paddle.
